(19) United States
(12) Patent Application Publication
(10) Pub. No.: US 2014/0330821 A1
(43) Pub. Date: Nov. 6, 2014

(54) RECOMMENDING CONTEXT BASED ACTIONS FOR DATA VISUALIZATIONS

(71) Applicant: MICROSOFT CORPORATION, Redmond, WA (US)

(72) Inventors: Steve Tullis, Redmond, WA (US); Uhl Albert, Kirkland, WA (US); David Gustafson, Boise, ID (US)

(73) Assignee: Microsoft Corporation, Redmond, WA (US)

(21) Appl. No.: 13/888,296

(22) Filed: May 6, 2013

(51) Int. Cl. G06F 17/30

(52) U.S. Cl. CPC G06F 17/30554
USPC 707/728; 707/722

(57) ABSTRACT

A data visualization application recommends context based actions for data visualizations. The application displays a visualization of a dataset. In response to detecting a query request associated with the visualization, contextual information for the data is used to construct a query. The application submits the query to search services for search indexes, structured data, and unstructured data. The returned results are displayed in summary format using actionable items. The actionable items update the visualization or provide new visualizations representing the results.

### BACKGROUND

People interact with computer applications through user interfaces. While audio, tactile, and similar forms of user interfaces are available, visual user interfaces through a display device are the most common form of user interface. With the development of faster and smaller electronics for computing devices, smaller size devices such as handheld computers, smart phones, tablet devices, and comparable devices have become common. Such devices execute a wide variety of applications ranging from communication applications to complicated analysis tools. Many such applications render visual effects through a display and enable users to provide input associated with the applications' operations.

Data manipulation and presentation applications typically involve a number of manual actions such as a user defining resources of data, resources for updates, updating the data, and recreating visualizations. Conventional systems with manual and multi-step input do not satisfy user needs for efficient and rapid data analysis. Efficient data analysis is crucial to responding the proliferation of data analysis and manipulation in regular business and personal use. Frequent updates to data from variety of resources and manual operations sideline legacy systems as insufficient data providers. In addition, a user can seldom be expected to have sufficient expertise to construct efficient queries and connect visualizations with data updates. An average user cannot be expected to learn technical skills necessary to drive complex data analysis to match demand. Query platforms seldom simplify solutions to meet expansive and growing data analysis needs of modern users. As a result, a disconnect exists between users interacting with visualizations, associated data, and data resources to generate complex data analysis results.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to recommending context based actions for data visualizations. According to some embodiments, an application, such as a data visualization application, may display a visualization associated with data. The visualization may be a representation of the data such as a graph presenting data analysis results. The application may detect a query request associated with the visualization. The query request may include context specific to the visualization.

The application may determine contextual information for data of the visualization. The contextual information may be defined by user interest on a portion of the data. A query may be constructed based on the contextual information in response to the query request. Alternative queries may be presented to a user for selection before execution of the query. The query may be submitted to one or more search service(s) for execution. The search service(s) may include local or remote resources with structured or unstructured data. Result(s) may be received from the search services. The result(s) may be presented for integration into the visualization.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example concept diagram of recommending context based actions for data visualizations according to some embodiments;

FIG. 2 illustrates an example of recommending context based actions for data visualizations according to embodiments;

FIG. 3 illustrates example communications between query engine and data resources for recommending context based actions for data visualizations according to embodiments;

FIG. 4 illustrates components of recommending context based actions for data visualizations according to embodiments;

FIG. 5 illustrates another example of recommending context based actions for data visualizations according to embodiments;

FIG. 6 is a networked environment, where a system according to embodiments may be implemented;

FIG. 7 is a block diagram of an example computing operating environment, where embodiments may be implemented; and

FIG. 8 illustrates a logic flow diagram for a process recommending context based actions for data visualizations according to embodiments.

### DETAILED DESCRIPTION

As briefly described above, context based actions may be recommended for data visualizations. An application, such as a data visualization application, may determine a contextual information for data associated with a visualization in response to a query request. A query may be constructed based on the contextual information and submitted to search services. The received results may be presented for integration into the visualization.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present disclosure is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for recommending context based actions for data visualizations. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

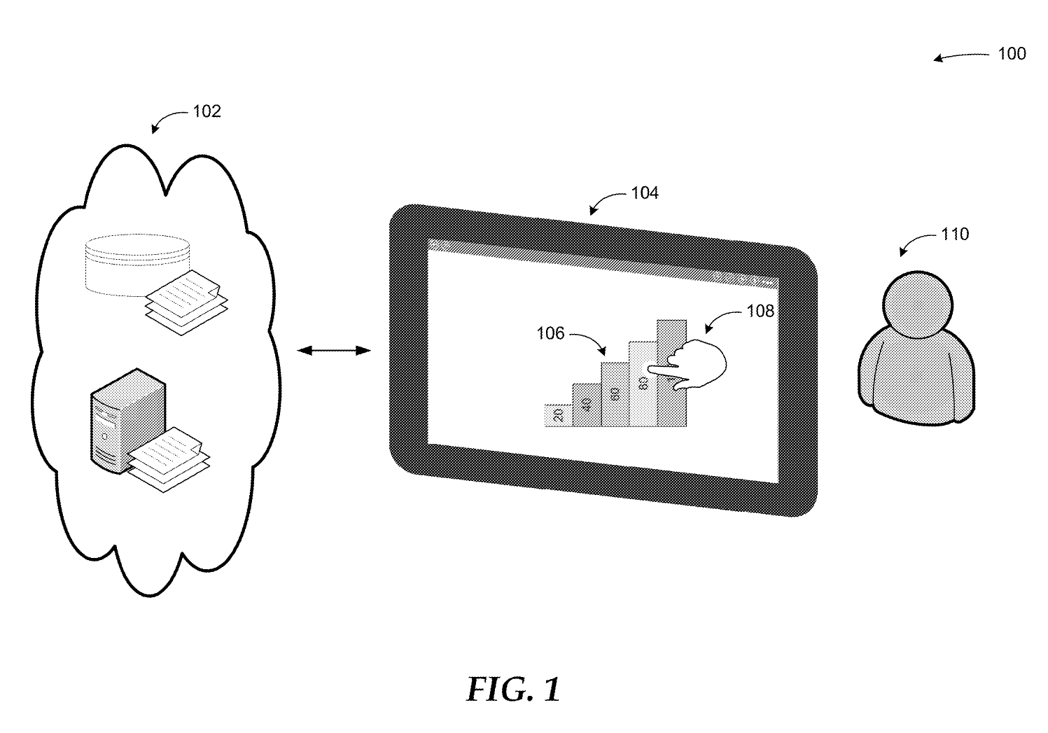

FIG. 1 illustrates an example concept diagram of requesting context based actions for data visualizations according to some embodiments. The components and environments shown in diagram 100 are for illustration purposes. Embodiments may be implemented in various local, networked, cloud-based and similar computing environments employing a variety of computing devices and systems, hardware and software.

A device 104 may display a visualization 106 to a user 110. The visualization 106 is presented by an application such as a data visualization application presenting data and associated visualizations. The visualization 106 may be a graph, a chart, a 3 dimensional (3D) representation, a graphic, an image, a video, etc. The visualization 106 may be a presentation of underlying data. The data may be manipulated through analysis by user or system. An example may include application of filters to data such as requesting a range or a subset of data to be displayed associated with a criteria. In addition, the application may enable a user to interact with the data through a gesture 108. The device 104 may recognize the gesture 108 through its hardware capabilities which may include a camera, a microphone, a touch-enabled screen, a keyboard, a mouse, etc.

The device 104 may communicate with external resources to update data associated with the visualization 106. The update may be in response to user interaction with the visualization 106. The user interaction such as gesture 108 may generate a query request which may be integrated with contextual information about the visualization to generate a query to submit to data service(s) 102. The data service(s) 102 may include remote resources such as a cloud hosted solution including data stores and content servers.

Embodiments are not limited to implementation in a device 104 such as a tablet. The application according to embodiments may be a local application executed in any device capable of displaying the application. Alternatively, the application may be hosted application such as a web service which may execute in a server while displaying application content through a client user interface such as a web browser. In addition to a touch-enabled device 104, interactions with the visualization 106 may be accomplished through other input mechanisms such as optical gesture capture, a gyroscopic input device, a mouse, a keyboard, an eye-tracking input, and comparable software and/or hardware based technologies.

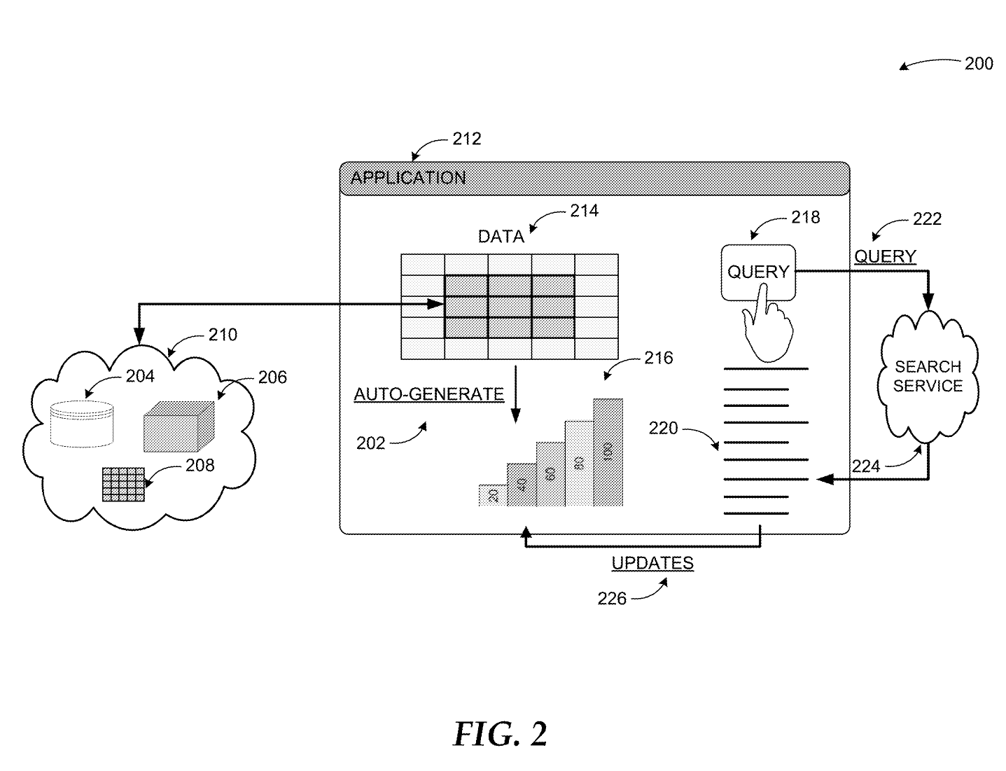

FIG. 2 illustrates an example of recommending context based actions for data visualizations according to embodiments. Diagram 200 displays an application 212 generating context based results 220 which are presented as actionable times to serve as updates to visualization 216 in response to query 222.

The application 212 may be a data visualization application as stated before. A data visualization application may be a spreadsheet application, a data store client interface, an accounting application, etc. The application 212 may present visualization 216 of the data 214. The data may be generated by external resources provided through a cloud hosted solution 210. The cloud hosted solution 210 may host a data store 204, a data cube 206, and structured data 208. The structured data 208 may be any indexed data categorized based on groupings.

The application may auto-generate 202 the visualization 216 based on data 214. The application may consider contextual information associated with the data 214 and prior use of the data 214. The contextual information may include user attributes such as user permissions, user role, user preferences, user interests, user location, and similar ones. The contextual information may also include organizational attributes, organizational roles, application attributes (i.e.: type of application), data resource attributes, data type, and similar ones. In an example scenario, the application may access a history table associated with the data 214 and recover prior use information in constructing a visualization. Upon matching a user to prior use information, the application may construct the visualization 216 matching the prior use information.

In addition, the auto-generated component of the application 212 may provide data connections to external resources to retrieve data based on the contextual information. Data connection information may be retrieved based on the contextual information to establish a data connection to a data resource associated with the contextual information. Data connections may be retrieved from a local or remote connection resource containing stored data connection information. The data connection to the search services may be established using the data connection information.

The application may detect a query request from an activated query control 218 through a user action. The application may generate a query 222 based on the context of the data associated with the visualization. An initial query may be provided by the user through query request from controls provided by the application such as a text box or option menus to define the query. The application may analyze contextual information associated with the data 214 to enhance the initial query prior to submission to search service 224. Alternatively, the application may auto-generate queries by matching prior queries to the contextual information and presenting the matching queries to the user for selection of the query 222. In another example scenario, the application may detect the user interacting with a portion of the visualization 216. In response to the interaction with the portion, the application may display prior queries associated with the portion for a user to select a query 222 matching the user's intent.

The application 212 may receive results 220 from search service 224. The search service 224 may include local and remote components. In another example scenario, the application may submit the query 222 to a search service 224 of a local data resource. In another example scenario, the application may submit the query 222 to a search service 224 of a remote data resource such as a search engine. The application may aggregate the results 220 and display them in a list structure in proximity to the query control 218. The application may display a text sample of data associated with the result. Alternatively, the results 220 may be displayed as graphic representations of updates that may be applied to the visualization 216. In another example scenario, the results 220 may be displayed as graphic representations of new visualizations. An example may include a pie chart showing at least one result to the query 222.

Selection of one of the results 220 will update the visualization 216. Alternatively, if the selected result is a new visualization then the application may replace the visualization 216 with the new visualization. In yet other embodiments, the application may select to display a new visualization adjacent to the visualization 216 in response to a user or a system preference.

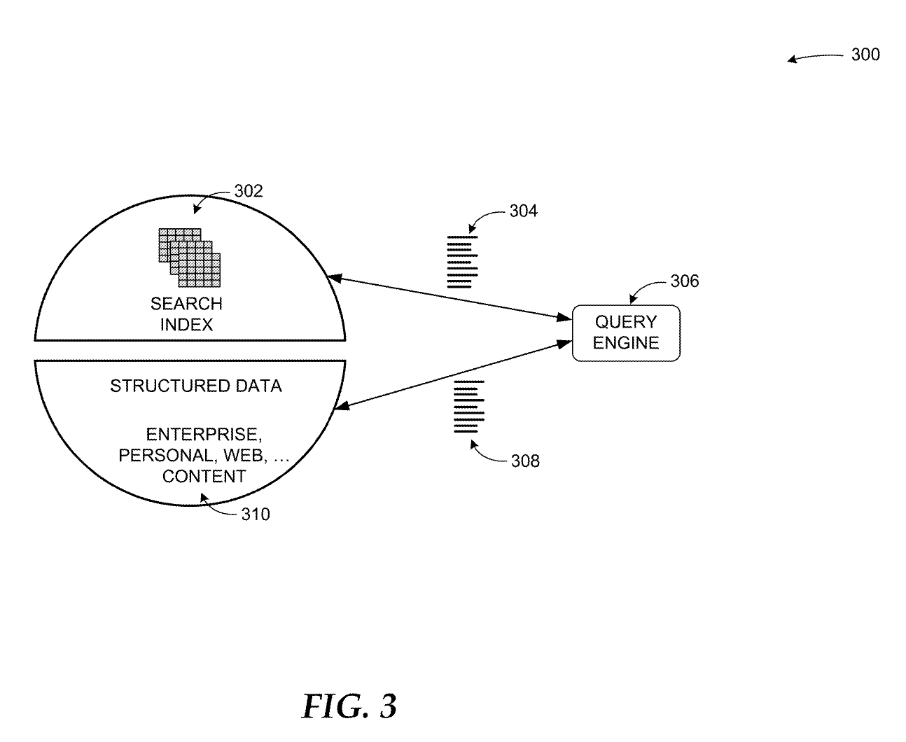

FIG. 3 illustrates example communications between query engine and data resources for recommending context based actions for data visualizations according to embodiments. Diagram 300 displays interactions between query engine 306 and data resources.

An application (i.e.: a data visualization application) may have a query engine 306 generating queries based on contextual information associated with data of the displayed visualization. The application may activate the query engine in response to user action initiating a query. The user action may be activation of a query control or interaction with the visualization as described above. The query engine may target a search index 302 as a primary data resource to submit the query. The search index may store analyzed data. An example may include a pivot table organizing the data based on an analysis criterion. In another example scenario, sales data may be pivoted based on quarterly income projections. Another common example of a search index is a data cube. Data cubes index data based on multiple criteria. Data cubes present instant access to data analysis based on the criteria parameters. The query engine may prioritize query submissions based on indexed data resources followed by other data resources. Result 304 may be retrieved faster than other resources because of the indexed nature of the search index 302. As a result, the query engine 306 may be enabled to stop executing query subsequent to receiving result 304. The application may provide query satisfaction attributes to define when to stop executing the query.

The query engine 306 may target a structured data resource 310 as an optional secondary data resource to execute the query simultaneously or subsequent to the query execution at the search index 302. The structured data may include multiple data resources such as enterprise, personal, web, and other content. The structured data resources may be structured based on data store attributes such as a relational data store format, extensible markup language (XML) format, or others. Structured data resource 310 may lack an index to enable quick searching the contained data. As a result, a query execution may take more time to retrieve a result 308 compared to a similar execution at search index 302.

The query engine 306 may also target an unstructured data resource as an optional tertiary data resource alternatively. Unstructured data may include raw data such as data stored in files. The unstructured data resource may take additional time to search the unstructured data to find match for the query compared to similar searches at search index 302 or structured data resource 310 The query engine 306 may analyze the results 304 and 308. The query engine 306 may aggregate the results 304 and 308 to eliminate duplicates. The query engine 306 may present results 304 and 308 to the application for updating associated visualization or to present as new visualizations.

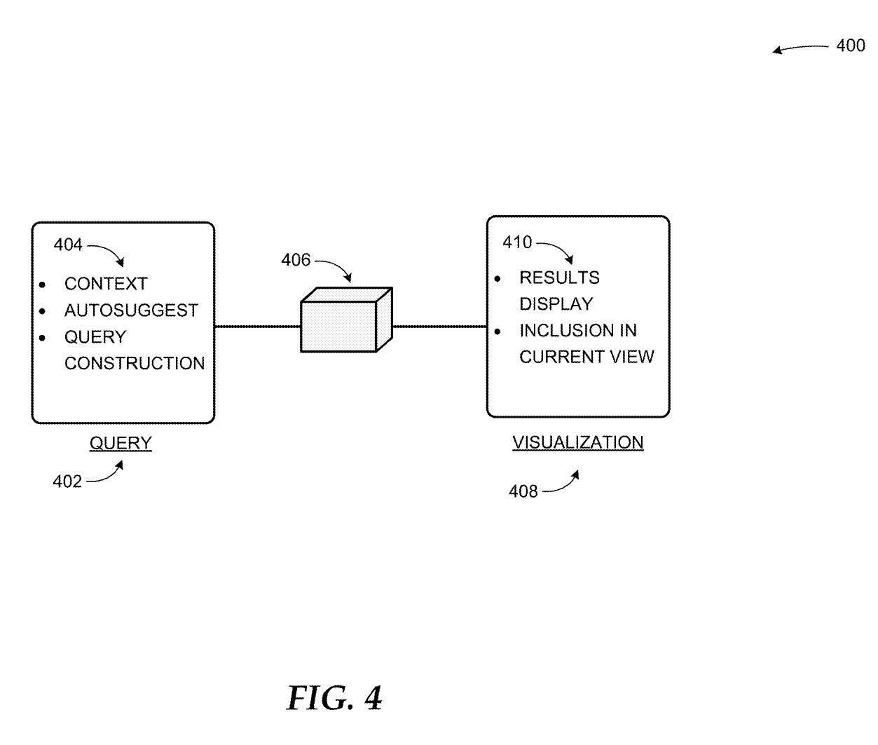

FIG. 4 illustrates components of recommending context based actions for data visualizations according to embodiments. Diagram 400 displays operations associated with query 402 and operations associated with visualization 408.

A recommendation module 406 of an application (i.e.: data visualization application) may execute multiple operations 404 to construct a query 402 and alter the visualization 408. The recommendation module 406 may determine contextual information associated with the data of the visualization such as user attributes, past utilization of the data or visualization, similarity of present utilization to past utilization, etc.

The recommendation module 406 may also automatically suggest a query based on the contextual information. The automatic suggestion may depend on multiple attributes such as prior query history, prior query utilization context, etc. In an example scenario, the recommendation module 406 may retrieve past queries from history and determine past query(s) matching user's intent. The recommendation module 406 may present the matching query(s) to user for selection.

In another operation, the recommendation module may construct a query based on contextual information. The query construction may involve attributes such as the user's interaction with the visualization and probable queries based on the interaction. The query construction may also add in data connections for data resources based on the user intent. Data connection selection may be based on prior history of finding results based on similar queries. In an example scenario, the recommendation module may access a query results table that stores query and results from past queries and maintains metrics on searches. The recommendation module may select queries based on number of returned results.

The recommendation module 406 may execute results operations 410. The recommendation module may present results in a summary format. The displayed summary items may be actionable. In addition, the results may be presented in a list structure sorted based on relevancy score. The relevancy score may be determined dynamically by the application based on an analysis scoring likelihood of a query matching the contextual information. A result may be ranked based on its relevancy score. A result with a high relevancy score may be presented before a result with a low relevancy score.

Additionally, the summary items may show a preview of results data, a graphic of updated visualization 408, or new visualizations based on the results. Results operations 410 may also include actionable results items for inclusion into the current view of a visualization. In response to selection of one of the actionable items, the application may update the visualization 408 or display new visualizations as described previously. The application may merge models and select appropriate format, style, and other attributes of the visualization when incorporating query result in the visualization.

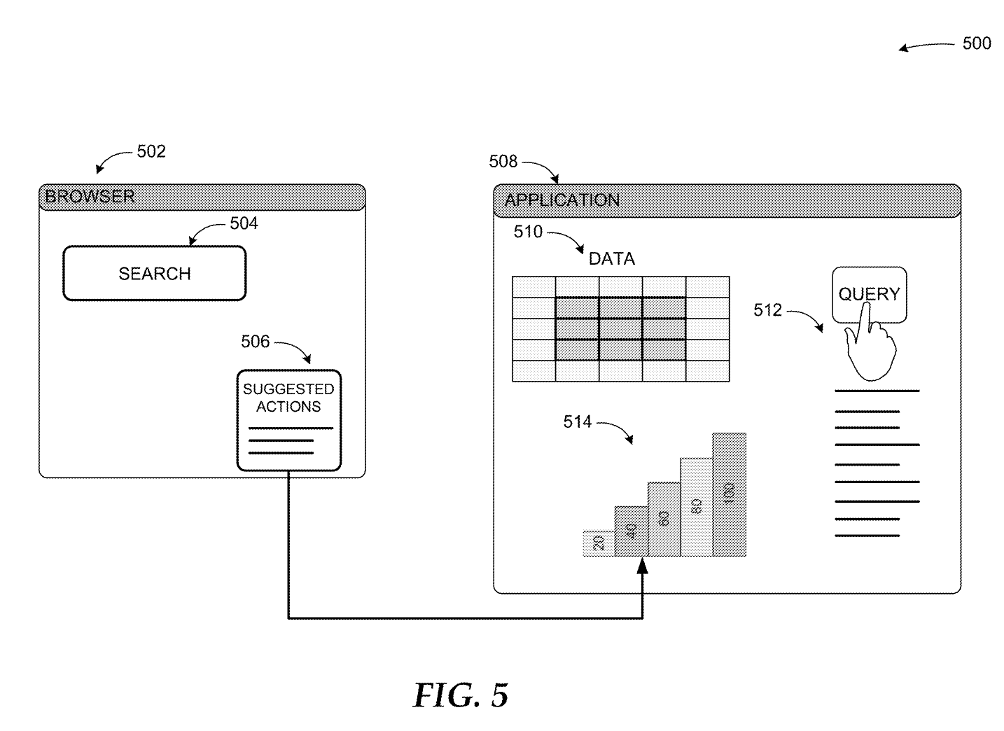

FIG. 5 illustrates another example of recommending context based actions for data visualizations according to embodiments. Diagram 500 illustrates using separate applications to auto-recommend updates to the visualization 514.

According to some embodiments, an external application such as a browser 502 may provide an interface to the application 508. The browser 502 may provide search control 504 to initiate a query based on data 510 of visualization 514. The application 508 may receive a query request from the external application (browser 502). Contextual information about the data 510 may be used to generate the query as discussed in relation to FIG. 2. The application may display the constructed query in its controls 512 and execute the query. The results may be displayed on the application 508 as well as the interface on the browser 502 as suggested actionable items 506. In response to activation of one of the suggested actionable items 506 in the browser 502, the application may apply updates found in the result to the visualization 514. The application may also select to display the result as a new visualization as discussed previously.

Embodiments are not limited to automatically recommending queries or results to update visualizations or provide new visualizations in response to the results. Embodiments may update data or provide new data presentations in response to results from automatically recommended queries. The application may also transmit the updated or new visualizations or data to corresponding data resource for updates to existing data or for storage as new data. Data connections utilized for the queries may be stored in application history for subsequent retrieval and utilization in subsequent similar query recommendations.

The example scenarios and schemas in FIG. 2 through 5 are shown with specific components, data types, and configurations. Embodiments are not limited to systems according to these example configurations. Recommending context based actions for data visualizations may be implemented in configurations employing fewer or additional components in applications and user interfaces. Furthermore, the example schema and components shown in FIG. 2 through 5 and their subcomponents may be implemented in a similar manner with other values using the principles described herein.

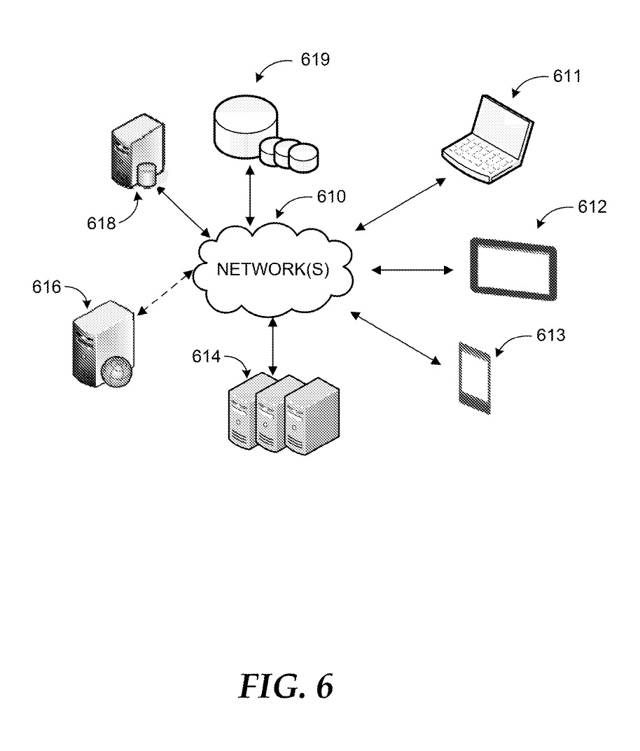

FIG. 6 is a networked environment, where a system according to embodiments may be implemented. Local and remote resources may be provided by one or more servers 614 or a single server (e.g. web server) 616 such as a hosted service. An application may execute on individual computing devices such as a smart phone 613, a tablet device 612, or a laptop computer 611 (‘client devices’) and communicate with a content resource through network(s) 610.

As discussed above, an application (i.e.: data visualization application) may recommend context based actions for data visualizations. The application may utilize contextual information associated with data of a displayed visualization in generating a query to update the visualization. The application may display results in actionable summary format which may be applied to the visualization as an update in response to user action selecting an actionable result. Client devices 611-613 may enable access to applications executed on remote server(s) (e.g. one of servers 614) as discussed previously. The server(s) may retrieve or store relevant data from/to data store(s) 619 directly or through database server 618.

Network(s) 610 may comprise any topology of servers, clients, Internet service providers, and communication media. A system according to embodiments may have a static or dynamic topology. Network(s) 610 may include secure networks such as an enterprise network, an unsecure network such as a wireless open network, or the Internet. Network(s) 610 may also coordinate communication over other networks such as Public Switched Telephone Network (PSTN) or cellular networks. Furthermore, network(s) 610 may include short range wireless networks such as Bluetooth or similar ones. Network(s) 610 provide communication between the nodes described herein. By way of example, and not limitation, network(s) 610 may include wireless media such as acoustic, RF, infrared and other wireless media.

Many other configurations of computing devices, applications, data resources, and data distribution systems may be employed to recommend context based actions for data visualizations. Furthermore, the networked environments discussed in FIG. 6 are for illustration purposes only. Embodiments are not limited to the example applications, modules, or processes.

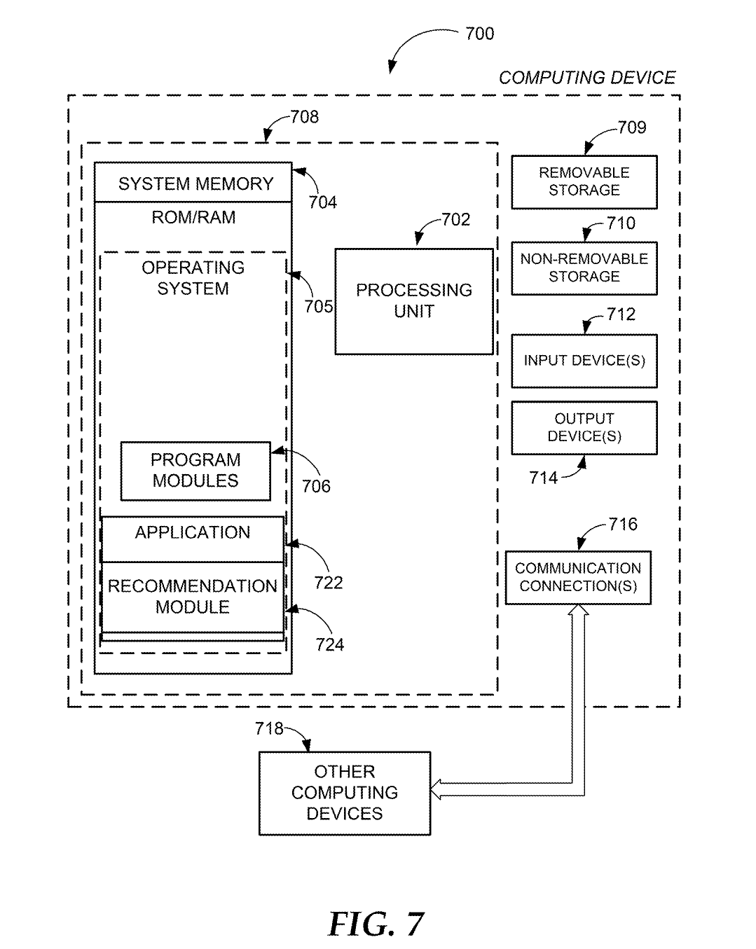

FIG. 7 and the associated discussion are intended to provide a brief, general description of a suitable computing environment in which embodiments may be implemented. With reference to FIG. 7, a block diagram of an example computing operating environment for an application according to embodiments is illustrated, such as computing device 700. In a basic configuration, computing device 700 may include at least one processing unit 702 and system memory 704. Computing device 700 may also include a plurality of processing units that cooperate in executing programs. Depending on the exact configuration and type of computing device, the system memory 704 may be volatile (such as RAM), non-volatile (such as ROM, flash memory, etc.) or some combination of the two. System memory 704 typically includes an operating system 705 suitable for controlling the operation of the platform, such as the WINDOWS® and WINDOWS PHONE® operating systems from MICROSOFT CORPORATION of Redmond, Wash. The system memory 704 may also include one or more software applications such as program modules 706, an application 722 such as a data visualization application, and a recommendation module 724.

An application 722 may detect a query request associated with a visualization. The recommendation module 724 may determine contextual information associated with data of the visualization and construct a query using the contextual information. The query may be submitted to search services by the application 722. The application 722 may display returned results in a summary format as actionable items for updating the visualization or to present as new visualizations. This basic configuration is illustrated in FIG. 7 by those components within dashed line 708.

Computing device 700 may have additional features or functionality. For example, the computing device 700 may also include additional data storage devices (removable and/or non-removable) such as, for example, magnetic disks, optical disks, or tape. Such additional storage is illustrated in FIG. 7 by removable storage 709 and non-removable storage 710. Computer readable storage media may include volatile and nonvolatile, removable and non-removable media implemented in any method or technology for storage of information, such as computer readable instructions, data structures, program modules, or other data. Computer readable storage media is a computer readable memory device. System memory 704, removable storage 709 and non-removable storage 710 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer readable storage media may be part of computing device 700. Computing device 700 may also have input device(s) 712 such as keyboard, mouse, pen, voice input device, touch input device, and comparable input devices. Output device(s) 714 such as a display, speakers, printer, and other types of output devices may also be included. These devices are well known in the art and need not be discussed at length here.

Computing device 700 may also contain communication connections 716 that allow the device to communicate with other devices 718, such as over a wireless network in a distributed computing environment, a satellite link, a cellular link, and comparable mechanisms. Other devices 718 may include computer device(s) that execute communication applications, storage servers, and comparable devices. Communication connection(s) 716 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

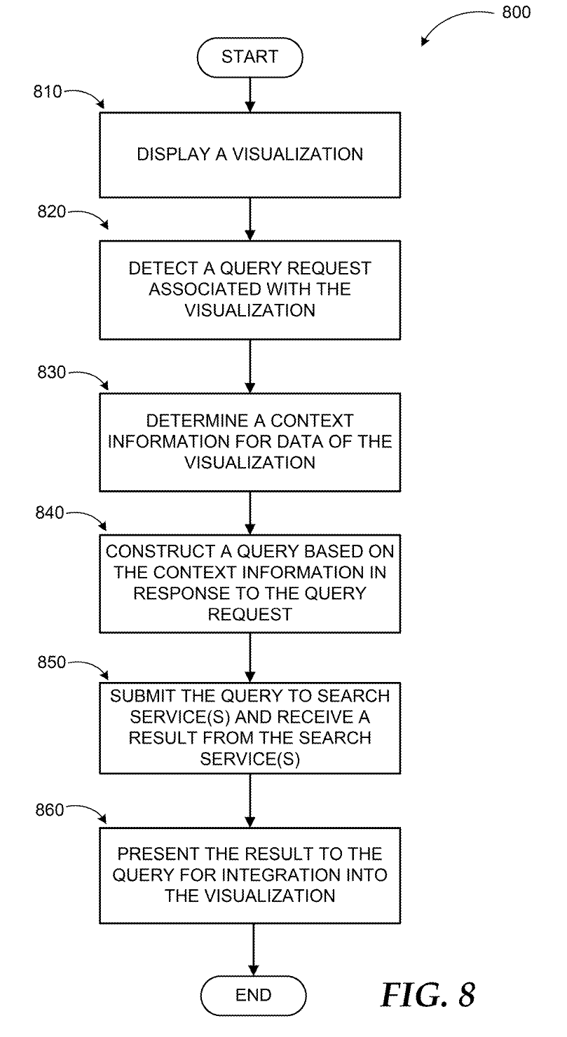

FIG. 8 illustrates a logic flow diagram for a process recommending context based actions for data visualizations according to embodiments. Process 800 may be implemented by an application, such as a data visualization application, in some examples.

Process 800 may begin with operation 810 where the application may display a visualization. The visualization may be a graph, a chart, etc. of a data. At operation 820, a query request may be detected associated with the visualization. The query request may be a query entry by a user or activation of controls associated with constructing a query. Next, the application may determine contextual information for data of the visualization at operation 830. The contextual information may include multiple attributes such as user attributes, user intent, historical actions associated with the visualization, prior queries, etc.

The application may construct a query based on the contextual information in response to the query request at operation 840. The query may be submitted to search service(s) and a result may be received from the search services at operation 850. Search services may include resources including a search index, a structured data resource, or an unstructured data resource. A result to the query may be presented for integration into the visualization at operation 860. The result may be displayed as an actionable item in summary format. The result may be used to update the visualization or to display as a new visualization.

Some embodiments may be implemented in a computing device that includes a communication module, a memory, and a processor, where the processor executes a method as described above or comparable ones in conjunction with instructions stored in the memory. Other embodiments may be implemented as a computer readable storage medium with instructions stored thereon for executing a method as described above or similar ones.

The operations included in process 800 are for illustration purposes. Recommending context based actions for data visualizations, according to embodiments, may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device for recommending context based actions for data visualizations, the method comprising:
displaying a visualization;
detecting a query request associated with the visualization;
determining contextual information for data of the visualization;
constructing a query based on the contextual information in response to the query request;
submitting the query to at least one search service and receiving a result from the at least one search service; and
presenting the result integrated into the visualization.

2. The method of claim 1, further comprising:
determining the contextual information from a user attribute including at least one of: a user permission, a user role; a user preference, a user interest.

3. The method of claim 1, further comprising:
determining the contextual information from at least one of: an organizational attribute, an application attribute, a data resource attribute, and a data type.

4. The method of claim 1, further comprising:
retrieving data connection information from a connection resource to establish a data connection to a data resource associated with the contextual information; and
establishing the data connection to the at least one search service using the data connection information.

5. The method of claim 1, further comprising:
matching a plurality of prior queries to the contextual information;
presenting the plurality of prior queries for selecting the query.

6. The method of claim 1, further comprising:
detecting an interaction with a portion of the visualization; and
displaying a plurality of prior queries associated with the portion for selecting the query.

7. The method of claim 1, further comprising:
submitting the query to the at least one search service of at least one of: a search index, a structured data resource, an unstructured data resource.

8. The method of claim 1, further comprising:
displaying the result in a summary format as an actionable item within a list structure sorted based on a relevancy score.

9. The method of claim 8, further comprising:
displaying a text sample of data associated with the result as the actionable item.

10. The method of claim 8, further comprising:
displaying a graphic representation of an update to the visualization as the actionable item.

11. The method of claim 8, further comprising:
displaying a graphic representation of a new visualization as the actionable item.

12. A computing device for recommending context based actions for data visualizations, the computing device comprising:
a memory configured to store instructions; and
a processor coupled to the memory, the processor executing an application in conjunction with the instructions stored in the memory, wherein the application is configured to:
display a visualization;
detect a query request associated with the visualization;
determine contextual information for data associated with the visualization;
construct a query based on the contextual information in response to the query request;
submit the query to at least one search service and receive a result from the at least one search service; and
display the result in a summary format as an actionable item within a list structure sorted based on relevancy score, presenting one of:
a text sample of data associated with the result as the actionable item,
a graphic representation of an update to the visualization as the actionable item, and
another graphic representation of a new visualization as the actionable item.

13. The computing device of claim 12, wherein the application is further configured to:
replace the visualization with the new visualization in response to at least one of: a user preference and a system preference; and
display the new visualization adjacent to the visualization in response to at least one of: a user preference and a system preference.

14. The computing device of claim 12, wherein the application is further configured to:
update the visualization with the result by merging models and using at least one of: a format and a style of the visualization while incorporating the result into the visualization in response to selection of the actionable item.

15. The computing device of claim 12, wherein the application is further configured to:
aggregate the result with duplicate results from other data resources of the at least one search service.

16. The computing device of claim 12, wherein the application is further configured to:
target a search index as a primary data resource;
target a structured data resource as an optional secondary data resource; and
target an unstructured data resource as an optional tertiary data resource.

17. A computer-readable memory device with instructions stored thereon for recommending context based actions for data visualizations, the instructions comprising:
displaying a visualization;
detecting a query request associated with the visualization;
determining contextual information for data associated with the visualization;
constructing a query based on the contextual information in response to the query request;
submitting the query to at least one search service and receiving a result from the at least one search service;
displaying the result in a summary format as an actionable item within a list structure sorted based on a relevancy score, presenting a graphic representation of an update to the visualization as the actionable item; and
updating the visualization with the result by merging models and using at least one of: a format and a style of the visualization while incorporating the result into the visualization in response to selection of the actionable item.

18. The computer-readable memory device of claim 17, wherein the instructions further comprise:
automatically suggesting the query based on the contextual information depending on prior attributes including at least one of: prior query history and prior query utilization context.

19. The computer-readable memory device of claim 17, wherein the instructions further comprise:
receiving another query request from an external application; and
constructing another query based on the contextual information in response to the other query request;
submitting the other query to the at least one search service and receiving another result from the at least one search service.

20. The computer-readable memory device of claim 19, wherein the instructions further comprise:
displaying the other result in the summary format as another actionable item within the list structure sorted based on another relevancy score presenting another graphic representation of another update to the visualization as the other actionable item; and
transmitting the other result to the external application to be displayed as a suggested actionable item.
